(19) United States
(12) Patent Application Publication
(10) Pub. No.: US 2026/0214619 A1
(43) Pub. Date: Jul. 23, 2026

(54) STATION POSITIONING SYSTEM, STATION POSITIONING DEVICE, STATION POSITIONING METHOD, AND STATION POSITIONING PROGRAM

(71) Applicant: NTT, Inc., Tokyo (JP)

(72) Inventors: Riku OMIYA, Musashino-shi, Tokyo (JP); Masashi IWABUCHI, Musashino-shi, Tokyo (JP); Tomoki MURAKAMI, Musashino-shi, Tokyo (JP); Ryotaro TANIGUCHI, Musashino-shi, Tokyo (JP); Tomoaki OGAWA, Musashino-shi, Tokyo (JP); Yasushi TAKATORI, Musashino-shi, Tokyo (JP)

(73) Assignee: NTT Inc., Tokyo (JP)

(21) Appl. No.: 19/139,387

(22) PCT Filed: Jan. 13, 2023
(86) PCT No.: PCT/JP2023/000822

§ 371 Date: Jun. 16, 2025

(51) Int. Cl. H04W 64/00; H04B 7/04

(52) U.S. Cl. CPC H04W 64/00; H04B 7/04013

(57) ABSTRACT

An installed station determination system according to an embodiment includes: ray tracing circuitry configured to perform ray tracing from a transmission point; first calculation circuitry configured to calculate propagation path power and a reflection point position of each propagation path that propagates an electromagnetic wave from the transmission point to a reception area in a line of sight after one reflection in the installed station candidate area; installed station area determination circuitry configured to determine the small area including the most reflection point positions as an installed station area of the RIS reflector; and second calculation circuitry configured to calculate, for the installed station area, an incident angle of the propagation path having the maximum propagation path power calculated by the first calculation circuitry and a reflection angle from a center of gravity based on the reflection point position to the reception area.

### TECHNICAL FIELD

The present invention relates to an installed station determination system, an installed station determination device, an installed station determination method, and an installed station determination program.

### BACKGROUND ART

In order to realize high speed and large capacity of radio access, it has attracted attention to utilize a high frequency band capable of securing a wide band. For example, the high speed and large capacity is realized using a 28-GHz band in the fifth generation mobile communication system, and using a 60-GHz band in IEEE 802.11 ad (millimeter wave wireless LAN system) which is a wireless LAN standard.

Radio waves in a high frequency band are more likely to be attenuated and less likely to be diffracted than radio waves in a low frequency band. Therefore, in a case of utilizing the high frequency band, there are problems that a transmission distance is short and that reception quality is greatly deteriorated due to shielding.

For example, in order to relay an electromagnetic wave from a transmission point to a reception point shielded in a line of sight, there is a repeater device called a reconfigurable intelligent surface (RIS) reflector capable of electrically changing element characteristics and dynamically controlling reflection characteristics of the electromagnetic wave.

In addition, a method of calculating an installed station position of a radio base station that relays an electromagnetic wave is known (see, for example, Non Patent Literature 1).

### CITATION LIST

### Non Patent Literature

Non Patent Literature 1: Takuto Arai and four others, “AMAP: Adaptive Movable Access Point System for Offloading Efficiency Enhancement”, IEICE Technical Report, RCS2016-43, May 2016, pp. 107-112

### SUMMARY OF INVENTION

### Technical Problem

In order to enhance an effect of the repeater such as the RIS reflector, it is necessary to install the RIS reflector or the like at a position where power from a transmitting station can be sufficiently received.

However, in the technique of the related art, it is only possible to calculate an installed station position of a radio base station emitting radio waves by itself, and it is difficult to calculate a suitable installed station position of the repeater such as the RIS reflector.

The present invention has been made in view of the above-described problem, and an object of the present invention is to provide an installed station determination system, an installed station determination device, an installed station determination method, and an installed station determination program capable of determining an installed station position suitable for increasing power to be relayed with respect to a RIS reflector that does not emit an electromagnetic wave by itself.

### Solution to Problem

An installed station determination system according to one aspect of the present invention is an installed station determination system that determines an installed station of a RIS reflector when an electromagnetic wave transmitted from a transmission point is relayed by reflection to a reception point in a reception area shielded by a line of sight, the installed station determination system including: a ray tracing unit that performs ray tracing from the transmission point with respect to an area including an installed station candidate area of the RIS reflector including a set of a plurality of subdivided small areas; a first calculation unit that calculates propagation path power and a reflection point position of each propagation path that propagates an electromagnetic wave from the transmission point to the reception area in the line of sight after one reflection in the installed station candidate area on the basis of a result of the ray tracing performed by the ray tracing unit; an installed station area determination unit that determines the small area including the most reflection point positions calculated by the first calculation unit as an installed station area of the RIS reflector; a second calculation unit that calculates, for the installed station area determined by the installed station area determination unit, an incident angle of the propagation path having the maximum propagation path power calculated by the first calculation unit and a reflection angle from a center of gravity based on the reflection point position calculated by the first calculation unit to the reception area; and an output unit that outputs the installed station area determined by the installed station area determination unit and values indicating the incident angle and the reflection angle calculated by the second calculation unit.

Further, an installed station determination device according to one aspect of the present invention is an installed station determination device that determines an installed station of a RIS reflector when an electromagnetic wave transmitted from a transmission point is relayed by reflection to a reception point in a reception area shielded by a line of sight, the installed station determination device including: a first calculation unit that calculates, on the basis of a ray tracing result obtained by performing ray tracing from the transmission point with respect to an area including an installed station candidate area of the RIS reflector including a set of a plurality of subdivided small areas, propagation path power and a reflection point position of each propagation path that propagates an electromagnetic wave from the transmission point to the reception area in the line of sight after one reflection in the installed station candidate area; an installed station area determination unit that determines the small area including the most reflection point positions calculated by the first calculation unit as an installed station area of the RIS reflector; a second calculation unit that calculates, for the installed station area determined by the installed station area determination unit, an incident angle of the propagation path having the maximum propagation path power calculated by the first calculation unit and a reflection angle from a center of gravity based on the reflection point position calculated by the first calculation unit to the reception area; and an output unit that outputs the installed station area determined by the installed station area determination unit and values indicating the incident angle and the reflection angle calculated by the second calculation unit.

Further, an installed station determination method according to one aspect of the present invention is an installed station determination method for determining an installed station of a RIS reflector when an electromagnetic wave transmitted from a transmission point is relayed by reflection to a reception point in a reception area shielded by a line of sight, the installed station determination method including: a ray tracing step of performing ray tracing from the transmission point with respect to an area including an installed station candidate area of the RIS reflector including a set of a plurality of subdivided small areas; a first calculation step of calculating propagation path power and a reflection point position of each propagation path that propagates an electromagnetic wave from the transmission point to the reception area in the line of sight after one reflection in the installed station candidate area on the basis of a result of the ray tracing performed in the ray tracing step; an installed station area determination step of determining the small area including the most reflection point positions calculated in the first calculation step as an installed station area of the RIS reflector; a second calculation step of calculating, for the installed station area determined in the installed station area determination step, an incident angle of the propagation path having the maximum propagation path power calculated in the first calculation step and a reflection angle from a center of gravity based on the reflection point position calculated in the first calculation step to the reception area; and an output step of outputting the installed station area determined in the installed station area determination step and values indicating the incident angle and the reflection angle calculated in the second calculation step.

### Advantageous Effects of Invention

According to the present invention, it is possible to determine the installed station position suitable for increasing the power to be relayed with respect to the RIS reflector that does not emit the electromagnetic wave by itself.

### BRIEF DESCRIPTION OF DRAWINGS

FIG. 1 is a diagram schematically illustrating an environment as a target for determining an installed station position of a RIS reflector by an installed station determination system according to an embodiment.

FIG. 2 is a diagram schematically illustrating a wall surface in the environment illustrated in FIG. 1.

FIG. 3 is a diagram illustrating a configuration example of an installed station determination system according to the embodiment.

FIG. 4 is a flowchart illustrating an operation example of the installed station determination system according to the embodiment.

FIG. 5 is a diagram illustrating a hardware configuration example of an installed station determination device according to the embodiment.

### DESCRIPTION OF EMBODIMENTS

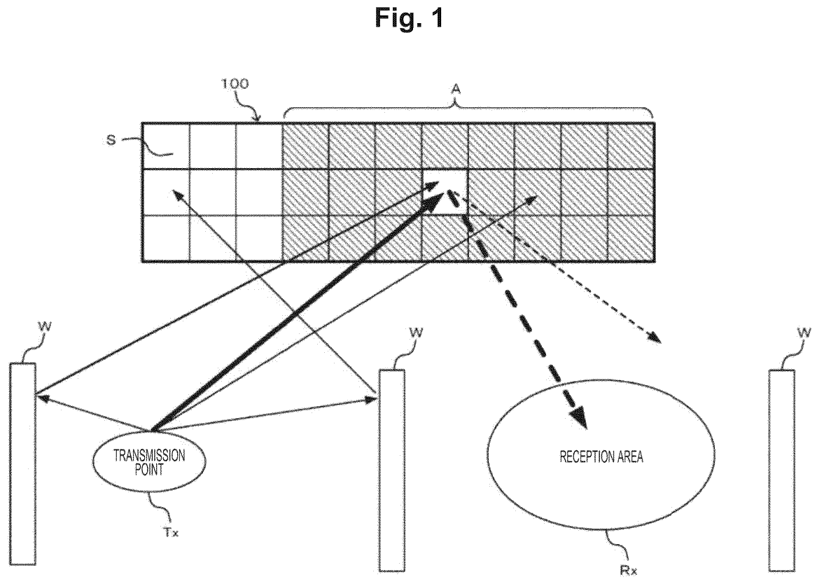

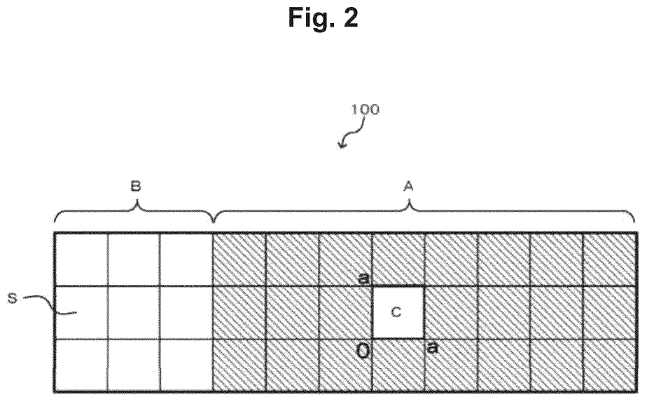

In describing an installed station determination system according to an embodiment, first, an environment as a target for determining an installed station position of a RIS reflector by the installed station determination system will be described with reference to FIGS. 1 and 2.

FIG. 1 is a diagram schematically illustrating an environment as a target for determining an installed station position of a RIS reflector by an installed station determination system according to an embodiment. FIG. 2 is a diagram schematically illustrating a wall surface 100 in the environment illustrated in FIG. 1.

Note that the RIS reflector to be a target for determining the installed station (position) is assumed to be a repeater for relaying an electromagnetic wave transmitted from a transmission point by reflection to a reception point in a reception area that is shielded by a line of sight. However, when the installed station determination system is used, the reception area is not necessarily shielded from the transmission point with the line of sight.

As illustrated in FIG. 1, a plurality of shielding objects W such as walls is arranged in the environment as a target for determining the installed station position of the RIS reflector. A transmission point Tx where a transmission device that transmits an electromagnetic wave (radio wave) is disposed and a reception area Rx where a reception device receives the electromagnetic wave are shielded by the shielding objects W in the line of sight.

Further, the wall surface 100 is a structure on which the RIS reflector can be installed. As also illustrated in FIG. 2, the wall surface 100 includes, for example, a set of small areas S subdivided into a plurality of square lattices (three in a vertical direction and eleven in a horizontal direction), and includes an installed station candidate area A of the RIS reflector and a non-installed station candidate area B of the RIS reflector.

As illustrated in FIG. 1, the installed station candidate area A of the RIS reflector is an area in which a propagation path can be formed to propagate the electromagnetic wave from the transmission point Tx to the reception area Rx in the line of sight after one reflection in the installed station candidate area A.

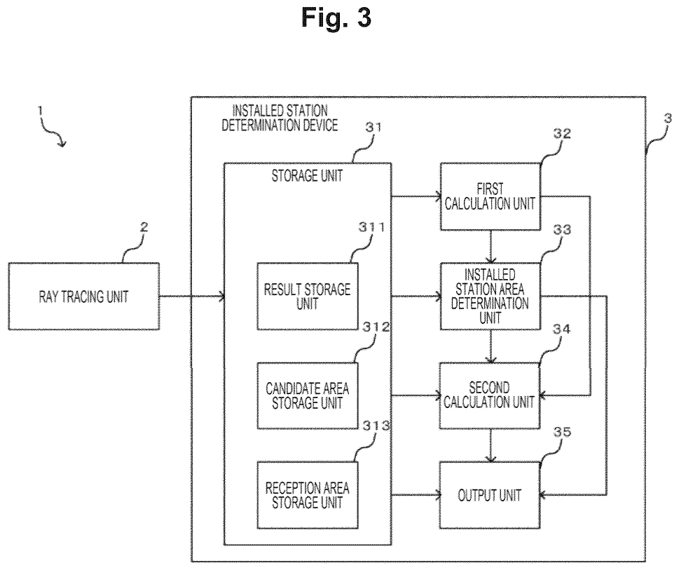

Next, a specific configuration example of an installed station determination system 1 according to the embodiment will be described. FIG. 3 is a diagram illustrating a configuration example of the installed station determination system 1 according to the embodiment. As illustrated in FIG. 3, the installed station determination system 1 includes, for example, a ray tracing unit 2 and an installed station determination device 3.

The ray tracing unit 2 executes ray tracing from the transmission point Tx on an area including the installed station candidate area A of the wall surface 100 (FIG. 1), and outputs a result of execution of the ray tracing to the installed station determination device 3.

The installed station determination device 3 includes, for example, a storage unit 31, a first calculation unit 32, an installed station area determination unit 33, a second calculation unit 34, and an output unit 35.

The storage unit 31 is, for example, a storage device including a result storage unit 311, a candidate area storage unit 312, and a reception area storage unit 313.

The result storage unit 311 stores a result of ray tracing performed by the ray tracing unit 2. The candidate area storage unit 312 stores information indicating a position of each of the small areas S of the wall surface 100, information indicating a position (range) of the installed station candidate area A, and the like. The reception area storage unit 313 stores information indicating a position (range) of the reception area Rx, and the like.

The first calculation unit 32 accesses the storage unit 31, calculates propagation path power and a reflection point position of each propagation path that propagates an electromagnetic wave from the transmission point Tx to the reception area Rx in the line of sight after one reflection in the installed station candidate area A on the basis of the result of ray tracing executed by the ray tracing unit 2, and outputs calculated results to the installed station area determination unit 33 and the second calculation unit 34.

The installed station area determination unit 33 accesses the storage unit 31, determines the small area S including the largest number of reflection point positions calculated by the first calculation unit 32 as an installed station area C (see FIG. 2) of the RIS reflector, and outputs a determined result to the second calculation unit 34 and the output unit 35.

The second calculation unit 34 calculates, for the installed station area C determined by the installed station area determination unit 33, an incident angle of the propagation path at which the propagation path power calculated by the first calculation unit 32 is maximum and a reflection angle from the center of gravity based on the reflection point position calculated by the first calculation unit 32 to the reception area Rx, and outputs calculated results to the output unit 35.

Furthermore, the second calculation unit 34 may calculate a reflection angle to the center of gravity of the reception area Rx or a reflection angle to an arbitrary reception point in the reception area Rx. Here, the second calculation unit 34 sets, for example, a geometric center or a geometric center weighted according to the propagation path power as the center of gravity.

For example, with the lower left of the small area S as the origin and the length of one side of the small area S as a, the second calculation unit 34 calculates the center of gravity of the small area S that has become the installed station area C as (a/2, a/2) or the like (see FIG. 2).

The output unit 35 outputs the installed station area determined by the installed station area determination unit 33 and values indicating the incident angle and the reflection angle calculated by the second calculation unit 34.

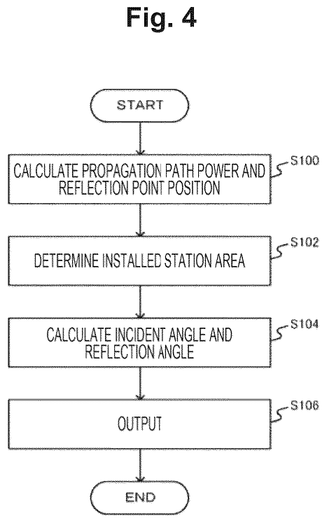

Next, an operation example of the installed station determination system 1 will be described. FIG. 4 is a flowchart illustrating the operation example of the installed station determination system 1 according to the embodiment. As illustrated in FIG. 4, the installed station determination system 1 calculates propagation path power and a reflection point position from the transmission point Tx to the reception area Rx (reception point) by ray tracing (S100).

Next, the installed station determination system 1 determines, as an installed station area C of the RIS reflector, a small area S including the most reflection point positions from the installed station candidate area A that is a line of sight to the reception area Rx (reception point) (S102).

Thereafter, the installed station determination system 1 calculates, with respect to the installed station area C, an incident angle of a propagation path having the maximum propagation path power and a reflection angle from the center of gravity based on the reflection point position to the reception area Rx (S104).

Then, the installed station determination system 1 outputs the installed station area, values indicating the incident angle and the reflection angle (S106).

As described above, the installed station determination system 1 determines the small area S including the most reflection point positions as the installed station area C of the RIS reflector, and calculates, with respect to the installed station area C, the incident angle of the propagation path having the maximum propagation path power and the reflection angle from the center of gravity based on the reflection point position to the reception area. Therefore, it is possible to determine the installed station position suitable for increasing the power to be relayed with respect to the RIS reflector that does not emit an electromagnetic wave by itself.

That is, the installed station determination system 1 can maximize incident power on the RIS reflector and maximize relay power to the reception point.

Further, some or all of the functions of the installed station determination device 3 may be configured with hardware such as a programmable logic device (PLD) or a field programmable gate array (FPGA) or may be configured as a program executed by a processor such as a CPU.

For example, the installed station determination device 3 according to the present invention can be implemented by using a computer and a program, and the program can be recorded in a storage medium or provided through a network.

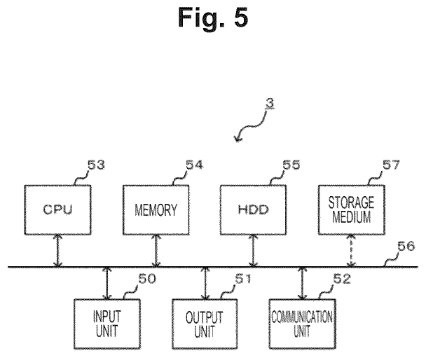

FIG. 5 is a diagram illustrating a hardware configuration example of the installed station determination device 3 according to an embodiment. As shown in FIG. 5, for example, the installed station determination device 3 has a function as a computer, in which an input unit 50, an output unit 51, a communication unit 52, a CPU 53, a memory 54, and an HDD 55 are connected via a bus 56. In addition, the installed station determination device 3 is made to be able to input and output data to and from a computer-readable storage medium 57.

The input unit 50 is, for example, a keyboard and a mouse or the like. The output unit 51 is, for example, a display device such as a display, and corresponds to the output unit 35 described above. The communication unit 52 is a wired or wireless network interface.

The CPU 53 controls each unit constituting the installed station determination device 3 and performs predetermined processing or the like. The memory 54 and the HDD 55 are storage units that store data and the like, and correspond to the storage unit 31 described above.

The storage medium 57 is made to be able to store a program or the like executing a function of the installed station determination device 3. Note that an architecture that configures the installed station determination device 3 is not limited to the example illustrated in FIG. 5.

The “computer” as used herein includes an OS and hardware such as peripheral devices. In addition, the “computer-readable storage medium” refers to a storage device such as a portable medium such as a flexible disk, a magneto-optical disc, a ROM, or a CD-ROM.

Further, the “computer-readable storage medium” may include a medium that dynamically holds a program for a short time, such as a communication line in a case where the program is transmitted via a network such as the Internet or a communication line such as a telephone line, or a medium that holds a program for a certain period of time, such as a volatile memory inside the computer system serving as a server or a client in that case.

Although the embodiment of the present invention has been described above with reference to the drawings, it is apparent that the above-described embodiment is merely an example of the present invention, and the present invention is not limited to the above-described embodiment.

Accordingly, addition, omission, substitution, and other changes of the components may be made without departing from the technical idea and the scope of the present invention.

### REFERENCE SIGNS LIST

1 Installed station determination system
2 Ray tracing unit
3 Installed station determination device
31 Storage unit
32 First calculation unit
33 Installed station area determination unit
34 Second calculation unit
35 Output unit
50 Input unit
51 Output unit
52 Communication unit
53 CPU
54 Memory
55 HDD
56 Bus
57 Storage medium
100 Wall surface
311 Result storage unit
312 Candidate area storage unit
313 Reception area storage unit

1. An installed station determination system that determines an installed station of a RIS reflector when an electromagnetic wave transmitted from a transmission point is relayed by reflection to a reception point in a reception area shielded by a line of sight,
the installed station determination system comprising:
ray tracing circuitry configured to perform ray tracing from the transmission point with respect to an area including an installed station candidate area of the RIS reflector including a set of a plurality of subdivided small areas;
first calculation circuitry configured to calculate propagation path power and a reflection point position of each propagation path that propagates an electromagnetic wave from the transmission point to the reception area in the line of sight after one reflection in the installed station candidate area on a basis of a result of the ray tracing performed by the ray tracing circuitry;
installed station area determination circuitry configured to determine the small area including the most reflection point positions calculated by the first calculation circuitry as an installed station area of the RIS reflector;
second calculation circuitry configured to calculate, for the installed station area determined by the installed station area determination circuitry, an incident angle of the propagation path having the maximum propagation path power calculated by the first calculation circuitry and a reflection angle from a center of gravity based on the reflection point position calculated by the first calculation circuitry to the reception area; and
output circuitry configured to output the installed station area determined by the installed station area determination circuitry and values indicating the incident angle and the reflection angle calculated by the second calculation circuitry.

2. The installed station determination system according to claim 1, wherein
the second calculation circuitry include
calculating a reflection angle to a center of gravity of the reception area or a reflection angle to an arbitrary reception point in the reception area.

3. The installed station determination system according to claim 1, wherein
the second calculation circuitry include
using a geometric center or a geometric center weighted according to the propagation path power as the center of gravity.

4. An installed station determination device that determines an installed station of a RIS reflector when an electromagnetic wave transmitted from a transmission point is relayed by reflection to a reception point in a reception area shielded by a line of sight,
the installed station determination device comprising:
first calculation circuitry configured to calculate, on a basis of a ray tracing result obtained by performing ray tracing from the transmission point with respect to an area including an installed station candidate area of the RIS reflector including a set of a plurality of subdivided small areas, propagation path power and a reflection point position of each propagation path that propagates an electromagnetic wave from the transmission point to the reception area in the line of sight after one reflection in the installed station candidate area;
installed station area determination circuitry configured to determine the small area including the most reflection point positions calculated by the first calculation circuitry as an installed station area of the RIS reflector;
second calculation circuitry configured to calculate, for the installed station area determined by the installed station area determination circuitry, an incident angle of the propagation path having the maximum propagation path power calculated by the first calculation circuitry and a reflection angle from a center of gravity based on the reflection point position calculated by the first calculation circuitry to the reception area; and
output circuitry configured to output the installed station area determined by the installed station area determination circuitry and values indicating the incident angle and the reflection angle calculated by the second calculation circuitry.

5. The installed station determination device according to claim 4, wherein
the second calculation circuitry include
calculating a reflection angle to a center of gravity of the reception area or a reflection angle to an arbitrary reception point in the reception area.

6. The installed station determination device according to claim 4, wherein
the second calculation circuitry include
using a geometric center or a geometric center weighted according to the propagation path power as the center of gravity.

7. An installed station determination method for determining an installed station of a RIS reflector when an electromagnetic wave transmitted from a transmission point is relayed by reflection to a reception point in a reception area shielded by a line of sight,
the installed station determination method comprising:
performing ray tracing from the transmission point with respect to an area including an installed station candidate area of the RIS reflector including a set of a plurality of subdivided small areas;
first calculating propagation path power and a reflection point position of each propagation path that propagates an electromagnetic wave from the transmission point to the reception area in the line of sight after one reflection in the installed station candidate area on a basis of a result of the ray tracing performed in performing ray tracing;
determining the small area including the most reflection point positions calculated in first calculating as an installed station area of the RIS reflector;
calculating, for the installed station area determined in determining, an incident angle of the propagation path having the maximum propagation path power calculated in first calculating and a reflection angle from a center of gravity based on the reflection point position calculated in first calculating to the reception area; and
outputting the installed station area determined in determining and values indicating the incident angle and the reflection angle calculated in second calculating.

8. A non-transitory computer-readable storage medium storing an installed station determination program for causing a computer to function as each circuitry of the installed station determination device according to claim 4.
